(19) United States
(12) Patent Application Publication
(10) Pub. No.: US 2009/0089805 A1
(43) Pub. Date: Apr. 2, 2009

(54) Profiling techniques and systems for computer programs

(75) Inventor: Ramanujan Kutta Srinivasan, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/904,863

(22) Filed: Sep. 28, 2007

(51) Int. Cl. G06F 9/54

(52) U.S. Cl. 719/318

(57) ABSTRACT

Profiling techniques and systems for analyzing a computer program at runtime produce profiles that attribute performance characteristics to specific sets of instructions invoked via generically-named native-code functions or virtual machine dispatch functions (“generic functions”). The computer program is instrumented at various points, such as upon entry into and/or exit from generic functions, to provide a parameter to the profiling system. Each parameter represents a particular specific set of instructions to be executed via the particular generic function. Receipt of a parameter triggers the addition of an attribution event record into an event log. The profiling system identifies within records within the event log for each unique combination of a parameter and a generic function address, and outputs a profile such as a call graph, which attributes performance characteristics (such as execution time or frequency) to the specific sets of instructions invoked via the generic functions.

### BACKGROUND

Host environments, which are physical environments such as computing units or platforms (for example, PCs, servers, game consoles, and other electronic devices) often execute computer programs that include generically-named native-code functions and/or virtual machine environment dispatch functions. A virtual machine environment is a non-physical environment that is created within a host environment and dispatched via functions that execute different, specific sets of instructions that are often not known by the host environment/computer program until runtime. Examples of such specific sets of instructions include but are not limited to client- or network-based applications invoked via an Internet browser program, and computer games invoked via a game console or PC.

Generally, computer programs are instrumented at compile-time to call profiling functions, which are components of profiling systems configured to measure, among other things, the frequency and duration of function calls within computer programs. Profiling systems usually output profiles, which list each function of interest in the computer program along with its execution time or other measured characteristic(s). One type of profile format is the call graph format. A wide variety of native-code and .NET/CLR profiling systems are commercially available. Such profiling systems, however, do not generally provide insight into the workings of generically-named native-code functions or virtual machine code, where the identity and number of specific sets of instructions executed may be known only at runtime and not at compile-time.

### SUMMARY

Profiling techniques and systems that provide insight into one or more performance characteristics of specific sets of instructions invoked via generically-named native-code functions or virtual machine dispatch functions (collectively referred to herein as “generic functions”) within a computer program running in a particular host environment are discussed herein.

In accordance with one technique, a computer program is instrumented at various points to provide a parameter (such as an index, a string, an integer, a pointer, or a hash value) to a profiling system at runtime. The parameter represents a specific set of instructions to be executed via a generic function. In one implementation, the parameter is an event identifier, and the computer program is instrumented at points associated with entry into generic functions to notify the profiling system of the event via the parameter.

Within the profiling system, data structures referred to as event records are used to record information about different types of events occurring in the computer program. An event log is a collection of event records organized in any desired manner, such as via a stack, queue, list, file, or database on a per-thread basis. A particular event type discussed herein is referred to as an “attribution event,” which is generally instrumented in the computer program to occur following an “entry event” associated with a generic function (there will also be a corresponding “exit event” that occurs upon exiting the generic function, although the attribution event may or may not be instrumented to occur following the exit event). The attribution event results in creation of an event record that includes the parameter received from the computer program at runtime, along with information such as the address of the generic function calling the specific set of instructions represented by the parameter.

The profiling system analyzes the event log and produces a profile (such as a call graph or another type of profile) based on one or more performance characteristics of the computer program. Examples of performance characteristics include but are not limited to execution time, instruction count, or cache memory access patterns associated with specific sets of instructions represented by the parameter. In one exemplary implementation, analysis of the event log includes identifying each unique combination of a parameter and generic function address from which the specific set of instructions represented by the parameter was invoked, creating an individual call graph node for each such unique combination, and building a call graph based on balanced entry events and exit events for each call graph node. In this manner, performance characteristics such as execution time, instruction count, or cache memory access patterns associated with generic functions are attributable to the specific sets of instructions/sub-calls invoked via such functions. Grouping the call graph nodes associated with a particular generic function address together (using any desired grouping technique, such as linking) also enables an access tool such as a user interface to present the call graph efficiently, in aggregated and non-aggregated form.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 is a simplified block diagram of a profiling system, which analyzes performance of a computer program at runtime and produces a profile that is accessed via a user interface.

FIG. 2 is a flowchart of a method for analyzing performance of a computer program at runtime.

FIG. 3 is a simplified block diagram of a general-purpose computing unit usable in connection with the system shown in FIG. I and/or the method shown in FIG. 2.

FIG. 4 is a simplified block diagram of an exemplary operating environment in which the system shown in FIG. I or the method shown in FIG. 2 may be implemented or used.

### DETAILED DESCRIPTION

Profiling techniques and systems discussed herein measure performance characteristics, such as the frequency and duration of function calls, among other things, of a computer program at runtime. The computer program is instrumented at various points, such as upon entry into a generically-named native-code function or a virtual machine dispatch function (collectively referred to herein as “generic functions”), to provide a parameter such as an index, a string, an integer, a pointer, or a hash value to a profiling system. The parameter represents a specific set of instructions to be executed via the generic function.

Upon receipt of the parameter, the call profiling system adds an “attribution event” record to an event log. In one exemplary implementation, the attribution event record only includes the parameter, and other information, such as the address of the generic function from which the specific set of instructions represented by the parameter was invoked, may be programmatically identified by determining which entry event/exit event pair a particular attribution event belongs to. Other implementations are possible, however, and as such attribution event records may include more or fewer items of information.

The profiling system analyzes the event log and outputs a profile., such as a call graph or another type of profile, which provides information regarding the measured performance characteristics of the computer program. Performance characteristics are attributed to specific sets of instructions invoked via generic functions by identifying each unique combination of a parameter and a function address calling the specific set of instructions represented by the parameter (using information within entry events and associated attribution events, for example). Since an attribution event appears in between a balanced entry/exit event pairing, it is possible to uniquely identify the particular balanced entry/exit event pair to which a particular attribution event belongs. The unique combinations having a common generic function address may be grouped together to enable an access tool such as a user interface to present the profile in aggregated and non-aggregated form. A user may use the profile to understand and improve behaviors of the computer program.

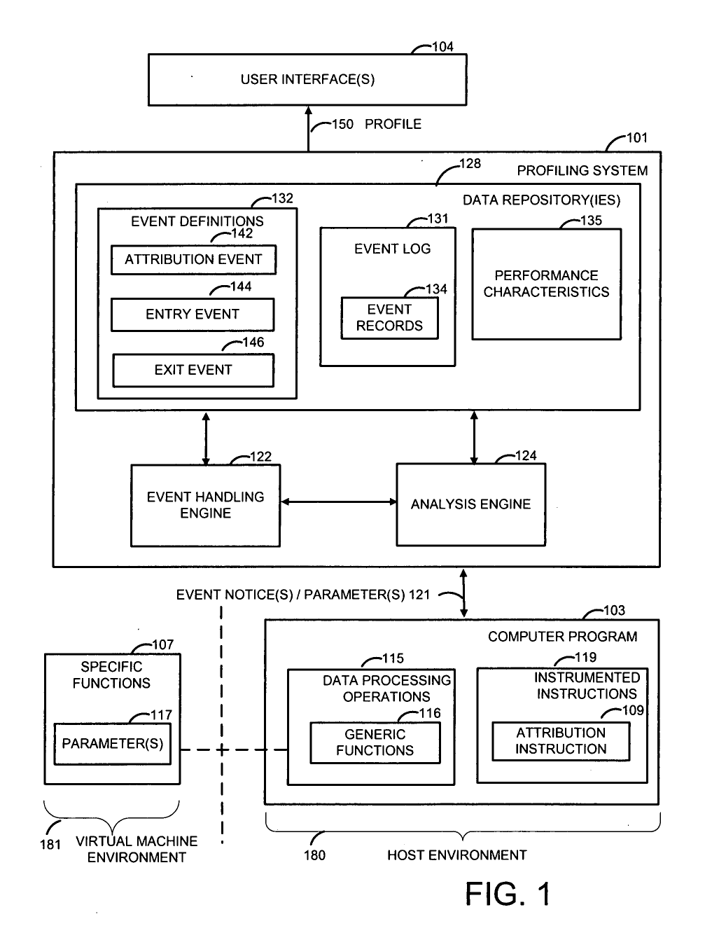

Turning now to the drawings, where like numerals designate like components, FIG. 1 is a simplified block diagram of an exemplary profiling system 101 for analyzing a computer program 103 at runtime to produce a profile 150, such as a call graph, which may be accessed via user interface(s) 104.

Computer program 103, which may be a single- or multiple-module program, is generally executed within a host environment 180 and includes multiple data processing operations 115 and instrumented instructions 119. Computer program 103 may be threaded code, composed substantially of calls to subroutines, or another type of code. Computer program 103, data processing operations 115, and/or instrumented instructions 119 may exist in one or more forms, such as in source code, object code, or executable code, among other forms.

Data processing operations 115 are computer-executable instructions configured to perform a predetermined operation on data (for example, any executable code is a data processing operation). A data processing operation may be referred to as a process, a task, a function, a routine, or by any other term now known or later adopted that designates the performance of predetermined operations on data. Certain data processing operations 115 of computer program 103 are generic functions 116 that execute different, specific sets of instructions (referred to as “specific functions”) 107 not generally known by the host environment/computer program until runtime. Examples of generic functions include but are not limited to generically-named native code functions and virtual machine dispatch functions. Examples of specific functions include but are not limited to client- or network-based applications or scripts (for example, Internet applications or interactive media content such as games).

Instrumented instructions 119 are calls to profiling system 101 inserted into computer program 103 at various places, for the purpose of monitoring aspects of execution of computer program 103. As computer program 103 executes, instrumented instructions 119 provide a stream of information (including but not limited to event notices and parameters 121, discussed further below) to profiling system 101. In one exemplary implementation, instrumented instructions 119 are calls to profiling system 101 (referred to as “event notices” and discussed further below) that, at runtime of computer program 103, trigger certain predefined events within profiling system 101 (event definitions 132 are discussed below in connection with profiling system 101).

Instrumented instructions 119 may be manually or automatically inserted into the source code, compiled code or other representation of computer program 103. Examples of places within computer program 103 where instrumented instructions 119 may be inserted include but are not limited to places associated with: the start of generic functions 116; the invocation of specific functions 107 via generic functions 116; and/or the end of generic functions 116. For discussion purposes, three types of instrumented instructions 119 are discussed herein: attribution instructions 109; entry instructions (not shown); and exit instructions (not shown). It will be appreciated, however, that a wide variety of instrumented instructions 119 that trigger associated events within profiling system 101 may be defined and inserted within computer program 103. Examples of additional instrumented instructions 119 include but are not limited to input/output instructions inserted at places within computer program 103 where input or output occurs, and thread swap instructions inserted at places within computer program 103 where thread switches occur.

Attribution instructions 109 are inserted at places within computer program 103 associated with the invocation of specific functions 107 via generic functions 116, and during execution of computer program 103 trigger attribution events 142 (discussed further below) within profiling system 101. Attribution instruction 109 causes computer program 103 to provide a parameter 121 (such as an index, a string, an integer, a pointer, or a hash value) to profiling system 101. Parameter 121 represents a specific function 107 to be executed via generic function 116. Oftentimes, the identity of specific function 107 is unknown until runtime of computer program 103.

Entry instructions are inserted at places within computer program 103 associated with the start of generic functions 116 or other functions. Exit instructions are inserted at places within computer program 103 associated with the end of generic functions 116 or other functions. During execution of computer program 103 entry instructions trigger entry events 144 (discussed further below) within profiling system 101, and exit instructions trigger exit events (also discussed further below) within profiling system 101.

The following exemplary pseudo-(source) code for a computer program called “Main( )” illustrates a generic function 116 (“ExecuteScript( )”), via which two specific functions 107 (“script_a” and “script_b”) are invoked. Script_a performs only basic arithmetic; script_b solves a mathematically intractable problem. An attribution instruction 109 (“PROFILER_DIFFERENTIATE_FUNCTION( )”) is used to trigger recordation of an attribution event 142 in the appropriate places.

```
    Void ExecuteScript(string ScriptName)
{
    Script scriptToExecute;
PROFILER_DIFFERENTIATE_FUNCTION(ScriptName); // or pass in
a numerical hash of the ScriptName, or unique index of the script
    scriptToExecute.Load(ScriptName);
    switch (scriptToExecute.PopNextCommand( ) )
    {
    case “Add”:
        Add(scriptToExecute.PopNextArguments( ) );
        break;
    case “Subtract”:
        Subtract (scriptToExecute.PopNextArguments( ) );
        break;
    // etc.
    case “TravelingSalesmanProblem”:
        SolveTravelingSalesmanProblem(scriptToExecute.-
        PopNextArguments( ) )
;
        break;
    // etc.
    }
}
void main ( )
{
    ExecuteScript (“script_a”); // adds a few numbers together
    ExecuteScript (“script_b”); // solves a 10,000 node traveling
    salesman problem
}
```

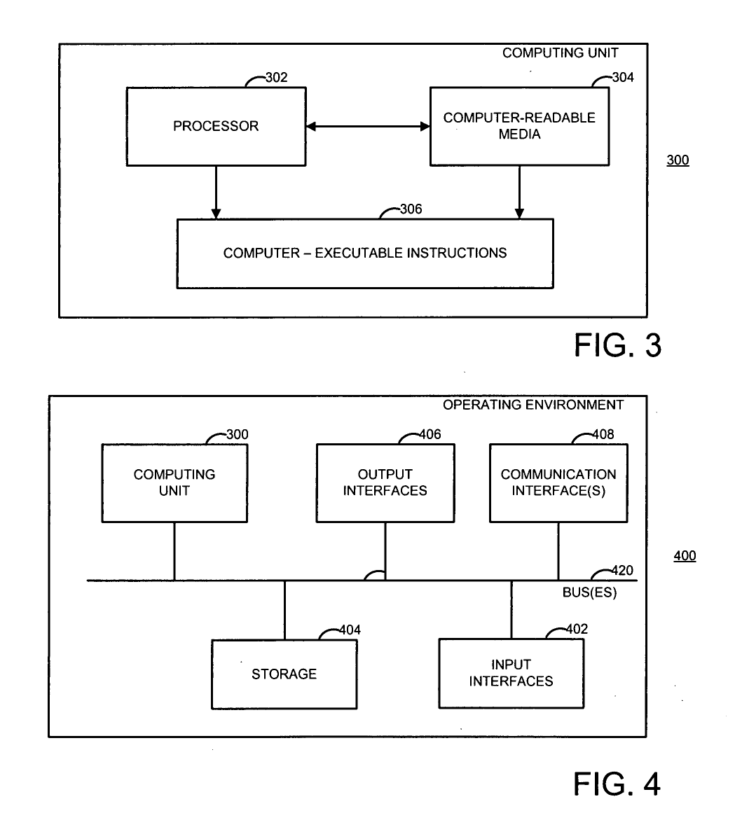

Profiling system 101 is responsible for collecting and analyzing the stream of information provided via instrumented instructions 119 as computer program 103 executes. In an exemplary implementation, profiling system includes an event handling engine 122, an analysis engine 124, and one or more data repositories 128. Data repository(ies) 128 represent computer-readable media 304 (shown and discussed in connection with FIG. 3) for storing certain data accessed or produced by event handling engine 122 or analysis engine 124, including but not limited to: event definitions 132; event log 131 (which is composed of event records 134); and performance characteristics 135. Profiling system 101 provides access to profile 150 to one or more user interfaces 104. Profile 150 is a summary of the observed events and/or performance characteristics 135, and may be in call graph form or another known or later developed format.

Event handling engine 122 is implemented by one or more arrangements of computer-executable instructions 306 (shown and discussed further below, in connection with FIG. 3) stored in one or more computer-readable media 304. In one possible implementation, event handling engine 122 comprises one or more profiling libraries that are invoked by computer program 103 via instrumented instructions 119. Event handling engine 122 is responsible for: receiving event notices and parameters 121 produced via execution of instrumented instructions 119 within computer program 103; based on the event notices and/or parameters 121 received from computer program 103, creating event records 134 based on event definitions 132; and generating/maintaining an event log 131, which is any known or later developed data structure such as a queue, a list, a stack, a file, or a database used to record information regarding events occurring within profiling system 101.

Event definitions 132 represent enumerated types of events that are recorded by profiling system 101 in response to instrumented instructions 119. For each type of event, the corresponding event definition includes the information to be recorded about the event via an event record 134. In an exemplary implementation, event definitions 132 include but are not limited to: entry events 144, which are recorded when an event notice is received via execution of entry instructions within computer program 103; exit events 146, which are recorded when an event notice is received via execution of exit instructions within computer program 103; and attribution events 142, which are recorded when an event notice and/or parameter 121 is received via execution of attribution instructions 109 within computer program 103.

Event records 134 are data structures, which may be entries within the data structure representing event log 131 or separate data structures, for storing information associated with different types of events such as entry events 144, exit events 146, and attribution events 142. Generally, an event record 134 is a fixed amount of memory within one or more data repositories 128 that is allocated to store certain information associated with each defined type of event. For example, event records 134 for storing information associated with attribution events 142 may have memory allocated to store the following items of information: the event type and the parameter 121 representing a particular specific function 107 invoked via the generic function. In many cases, a machine word may be used for storing each item. Event records 134 for storing information associated with entry events 144 and exit events 146 may have memory allocated to store the following items of information: the event type; the start address associated with a particular generic function 116 or other function invoked via computer program 103; and a time stamp. Since event records 134 for storing information associated with attribution events 142 generally appear in event log 131 between event records associated with a balanced pair of entry and exit events 144 and 146, respectively, it is possible to programmatically uniquely identify the particular balanced entry/exit event pair to which a particular attribution event belongs.

Analysis engine 124 is implemented by one or more arrangements of computer-executable instructions 306 (shown and discussed further below, in connection with FIG. 3) stored in one or more computer-readable media 304 (also shown and discussed in connection with FIG. 3) that are responsible for accessing and/or producing certain information stored in data repository(ies) 128, such as event log 131 and/or event records 134, to identify performance characteristics 135 of computer program 103, and producing profile 150. Examples of performance characteristics 135 include but are not limited to the frequency and duration of calls to generic functions 116 and/or specific functions 107, instruction counts, cache memory access patterns, and the like. Performance characteristics 135/profile 150 may then be accessed by a user (not shown) via user interface(s) 104, and used to understand and improve behaviors of computer program 103. Other access tools (not shown), such as APIs or software development tools, may also be provided by profiling system 101.

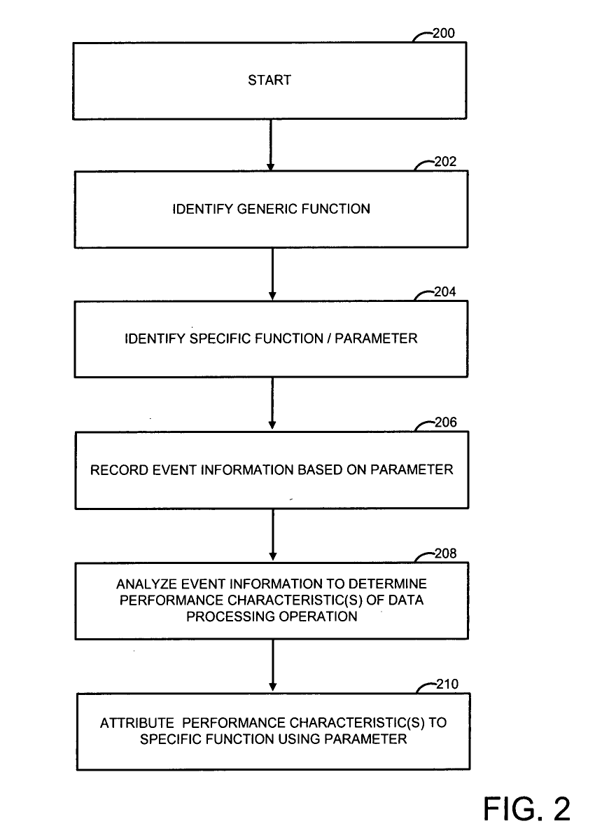

With continuing reference to FIG. 1, FIG. 2 is a flowchart of a method for analyzing performance of a computer program, such as computer program 103, at runtime. The method shown in FIG. 2 may be implemented in one or more general, multi-purpose, or single-purpose processors, such as processor 302 discussed below in connection with FIG. 3. Unless specifically stated, the methods described herein are not constrained to a particular order or sequence. In addition, some of the described methods or elements thereof can occur or be performed concurrently.

The method begins at block 200, and continues at block 202, where a generic function is identified. At block 204, a specific function, such as specific function 107, is identified, along with a parameter, such as parameter 121, which represents the specific function. Next, event information is recorded based on the parameter, as indicated at block 206.

In the context of one exemplary implementation of profiling system 101, which is configured to analyze running computer program 103, a particular generic function 116 may be identified when an entry instruction within computer program 103 is executed, resulting in information associated with an entry event 144 (such as the event type, the start address associated with the particular generic function 116 invoked via computer program 103, and a timestamp) being handled (by event handling engine 122, for example). Generally, information associated with the entry event is recorded by profiling system 101 within an event record 134/event log 131. In one possible implementation, information associated with the entry event is written onto a call stack--the event type (entry event), the return address of the generic function, and the timestamp (among other desired items) are written within an allocated amount (based on event definition 132 for entry event 144) of call stack memory.

A particular specific function 107 may be identified when an attribution instruction 109 within computer program 103 is executed, resulting in information associated with an attribution event 142 (such as the event type and parameter 121 representing the specific function) being handled (by event handling engine 122, for example). Generally, information associated with the attribution event is recorded by profiling system 101 within an event record 134/event log 131. In one possible implementation, information associated with the attribution event is written onto the call stack—the event type (attribution event) and the parameter are written within an allocated amount (based on event definition 132 for attribution event 142) of call stack memory. Since event records 134 for storing information associated with attribution events 142 generally appear in event log 131 between event records associated with a balanced pair of entry and exit events 144 and 146, respectively, it is possible to uniquely associate a particular parameter with a particular generic function address. As discussed above, a specific function 107, and the particular parameter 121 representing the specific function (which may be any unique identifier, including but not limited to a string, an integer, a pointer, or a hash), may not be known until runtime of computer program 103.

Optionally, an exit event 146 may be instrumented into computer program 103 and handled by profiling system 101, resulting in information such as the event type (exit event), the start address associated with the particular generic function 116 and/or specific function 107) invoked via computer program 103 or generic function 116 being exited, and the timestamp) may be written to the call stack.

Information within event records 134 and/or event log 131 may exist only temporarily (for example, as an in-memory representation) during certain operations of profiling system 101, or may be stored in ways that enhance the scalability of profiling system 101, such as being stored in files, databases, or other structures that allow the information to be re-used. When stored, event records 134 and/or event log 131 may be stored using any type of data structure, format, file, or database.

Table 1 illustrates the type of information recorded within an event log 131 for various types of events occurring during execution of an exemplary computer program 103 (shown in the above exemplary pseudo-code) called “Main.” Parameters 121 are strings representing the names of specific functions 107 (“script_a” and “script_b”) invoked via generic function 107 (“ExecuteScript( )”).

TABLE 1

| Event type | Function | Time Stamp or Parameter |
|---|---|---|
| Enter event | Main( ) | 1000 |
| Enter event | ExecuteScript( ) | 1100 |
| Attribute event | ExecuteScript( ) | “script_a” |
| Enter | Script::Load( ) | 1300 |
| Exit | Script::Load( ) | 2500 |
| Enter | Script::PopNextArguments( ) | 2600 |
| Exit | Script::PopNextArguments( ) | 2650 |
| Enter | Add( ) | 2700 |
| . . . | . . . | . . . |
| Exit | ExecuteScript( ) | 3000 |
| Enter | ExecuteScript( ) | 3100 |
| Attribute event | ExecuteScript( ) | “script_b” |
| Enter | Script::Load( ) | 3200 |
| . . . | . . . | . . . |
| Enter | SolveTravelingSalesman( ) | 100000 |
| Exit | ExecuteScript( ) | 100100 |

Referring again to the flowchart of FIG. 2, at block 208 the event information is analyzed to determine performance characteristic(s) of data processing operations associated with the computer program, and at block 210, the performance characteristic(s) are attributed to the specific function using the parameter (identified at block 204). In the context of profiling system 101, event log 131 may be analyzed (via analysis engine 124, for example) to determine certain performance characteristics 135, such as the frequency and duration of calls to generic functions 116 and/or specific functions 107, and to produce profile 150.

In one exemplary implementation, analysis of event log 131 may be performed using one or more data flow analysis techniques, which involve establishing unique nodes of function call graph based on information recorded within the event log, and balancing the outputs and the inputs associated with each unique node by traversing the call stack in a serial and/or iterative manner. The unique nodes may be linked and/or grouped together as desired. For example, in the context of profiling system 101/computer program 103, the following unique nodes of a function call graph may be established: nodes for particular generic functions 116 (and other functions) based on entry and/or exit events recorded within event log 131; and nodes for unique combinations of particular generic functions 116 and parameters 121 based on attribution events recorded within event log 131. Then, based on the contents of the event log, enter events and exit events may be associated with both generic functions 116 (and other functions) and specific functions 107, and balanced for each unique node of the function call graph. One possible performance characteristic 135 is obtained by ascertaining times (based on recorded timestamp information) between balanced enter and exit events associated with unique nodes of the function call graph.

Access to performance characteristic(s) 135 is provided via profile 150. In one exemplary implementation, profile 150 is a call graph, which includes data about the unique nodes of the function call graph, and the performance characteristics 135 thereof. A user interface 104, such as a graphical user interface, may also be provided to present profile 150 to a user in a format (such as a table presented in a window of a visual display). Various controls may be presented to the user (for example, in another portion of the user interface), which allow the user to receive the profile in different formats. One example of a control is an option to “aggregate” or “un-aggregate” the profile—the user may view the execution duration of computer program 103 in the aggregate, or along axes of one or more unique nodes of the function call graph.

In one exemplary scenario, durations and frequencies of calls to generic functions 116 (and other functions) may be presented. Table 2 is an exemplary (call graph) profile 150 presented via user interface 104 that presents the execution frequency and duration of the generic function “ExecuteScript” (shown in the above exemplary pseudo-code) within the computer program called “Main.”

TABLE 2

| Function | # of Calls | Total Time |
|---|---|---|
| Execute Script | 2 | 98900 |
| SolveTravelingSalesman | 1 | 96000 |
| Add | 1 | 100 |

In another exemplary scenario, the breakdown of frequencies and durations of generic functions and the individual specific functions invoked thereby may be presented. In this manner, the user receives an indication of which specific function(s) did most of the work, and which specific function(s) were executed within the same generic function. Furthermore, it is possible to ascertain which piece of data leads to particular observed behavior in a computer program. This functionality is especially useful as complexity increases—when hundreds of specific functions are executed, when nested specific functions are executed, and/or when there is overlap in various generic functions calling the same (nested) specific functions—the user interface is able to display unique nodes of the profile clearly and efficiently. Table 3 is an exemplary (call graph) profile 150 presented via user interface 104 that presents the execution frequency and duration of the generic function “ExecuteScript” within the computer program called “Main,” along with the execution frequency and duration of the specific functions “script_a” and “script_b”, which are invoked from the generic function.

TABLE 3

| Function | # of Calls | Total Time |
|---|---|---|
| Execute Script | 2 | 98900 |
| “script_a” | 1 | 1900 |
| “script_b” | 1 | 97000 |
| SolveTravelingSalesman | 1 | 96000 |
| Add | 1 | 100 |

FIG. 3 is a block diagram of a general-purpose computing unit 300, illustrating certain functional components that may be used to implement, may be accessed by, or may be included in, various elements shown in FIG. 1. A processor 302 is responsive to computer-readable storage media 304 and to computer programs 306. Processor 302, which may be a real or a virtual processor, controls functions of an electronic device by executing computer-executable instructions.

Computer-readable media 304 represent any number and combination of local or remote devices, in any form, now known or later developed, capable of recording, storing, or transmitting computer-readable data, such as computer-executable instructions 606 or media signals 21. In particular, computer-readable media 604 may be, or may include, a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; a paper tape; a punch card; or any combination thereof. Computer-readable media 604 may also include transmission media and data associated therewith. Examples of transmission media/data include, but are not limited to, data embodied in any form of wireline or wireless transmission, such as packetized or non-packetized data carried by a modulated carrier signal.

Computer-executable instructions 306 represent any signal processing methods or stored instructions. Generally, computer-executable instructions 606 are implemented as software components according to well-known practices for component-based software development, and encoded in computer-readable media (such as computer-readable media 304). Computer programs may be combined or distributed in various ways. Computer-executable instructions 306, however, are not limited to implementation by any specific embodiments of computer programs, and in other instances may be implemented by, or executed in, hardware, software, firmware, or any combination thereof.

With continued reference to FIG. 3, FIG. 4 is a block diagram of an exemplary configuration of an operating environment 400 in which profiling system 101 and/or the method(s) shown in FIG. 2 may be implemented or used. Operating environment 400 is generally indicative of a wide variety of general-purpose or special-purpose computing environments. Operating environment 400 is only one example of a suitable operating environment and is not intended to suggest any limitation as to the scope of use or functionality of the system(s) and methods described herein. For example, operating environment 400 may be a type of computer, such as a personal computer, a workstation, a server, a portable device, a laptop, a tablet, or any other type of computing device now known or later developed, or any aspect thereof. Operating environment 400 may also be a distributed computing network or a Web service, for example.

As shown, operating environment 400 includes or accesses components of a computing unit, including one or more processors 302, computer-readable media 304, and computer programs 306.

Storage 404 includes additional or different computer-readable media associated specifically with operating environment 400, such as an optical disc or other portable or fixed media. One or more internal buses 420, which are well-known and widely available elements, may be used to carry data, addresses, control signals and other information within, to, or from operating environment 400 or elements thereof.

Input interface(s) 402 provide input to computing environment 400. Input may be collected using any type of now known or later-developed interface, such as a user interface. User interfaces may be touch-input devices such as remote controls, displays, mice, pens, styluses, trackballs, keyboards, microphones, scanning devices, and all types of devices that are used input data.

Output interface(s) 406 provide output from operating environment 400. Examples of output interface(s) 406 include displays, printers, speakers, drives, user interfaces, and the like.

Communication interface(s) 408 are available to enhance the ability of operating environment 400 to receive information from, or to transmit information to, another entity via a communication medium such as a channel signal, a data signal, or a computer-readable medium. Communication interface(s) 408 may be, or may include, elements such as cable modems, data terminal equipment, media players, data storage devices, personal digital assistants, or any other device or component/combination thereof, along with associated network support devices and/or software or interfaces.

Exemplary configurations of profiling system 101 and elements thereof have been described. It will be understood, however, system I 01 may include fewer, more or different components or functions than those described herein.

Functions/components described herein as being computer programs are not limited to implementation by any specific embodiments of computer programs. Rather, such functions/components are processes that convey or transform data, and may generally be implemented by, or executed in, hardware, software, firmware, or any combination thereof.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

What is claimed is:

1. A computer-readable storage medium encoded with computer-executable instructions which, when executed by a processor, perform a method for analyzing performance of a computer program at runtime, the computer program having a plurality of data processing operations, the method comprising:
receiving notification of an occurrence of a predetermined event within the computer program, the predetermined event associated with a data processing operation comprising a generically-named native code function or a virtual machine dispatch function;
receiving from the computer program a parameter associated with the predetermined event, the parameter representing a specific set of instructions executable in connection with the data processing operation;
recording information regarding the predetermined event;
analyzing the recorded information to ascertain a performance characteristic of the specific set of instructions, a portion of a performance characteristic of the data processing operation attributable to the specific set of instructions based on the parameter; and
providing user access to the performance characteristic of the specific set of instructions.

2. The computer-readable storage medium according to claim 1, wherein the method further comprises:
as execution of the computer program progresses, receiving notification of an occurrence of an additional predetermined event associated with the data processing operation;
receiving from the computer program an additional parameter associated with the additional predetermined event and representing an additional specific set of instructions executable in connection with the data processing operation;
recording additional information regarding the additional predetermined event;
analyzing the additional recorded information to ascertain a performance characteristic of the additional specific set of instructions, a portion of the performance characteristic of the data processing operation attributable to the additional specific set of instructions based on the additional parameter; and
providing user access to the performance characteristic of the additional specific set of instructions.

3. The computer-readable storage medium according to claim 2, wherein the predetermined event and the additional predetermined event comprise function attribution events.

4. The computer-readable storage medium according to claim 1, wherein the parameter is selected from the group comprising: a string; an integer; a pointer; and a hash.

5. The computer-readable storage medium according to claim 1, wherein the specific set of instructions is unknown until runtime of the computer program.

6. The computer-readable storage medium according to claim 1, wherein the step of recording information comprises storing data selected from the group comprising: the parameter; identification of the data processing operation; and a type of the predetermined event within a data structure, the data structure selected from the group comprising: a queue; a list; a stack; a file; and a database.

7. The computer-readable storage medium according to claim 1, wherein the performance characteristic of the specific set of instructions is selected from the group comprising: an execution frequency; an execution duration; an instruction count; and a cache memory access pattern.

8. The computer-readable storage medium according to claim 1, wherein the method further comprises:
receiving notification of an entry event within the computer program, the entry event occurring upon entry of the computer program into the data processing function;
associating the parameter with the entry event to form a function identifier;
receiving notification of an exit event within the computer program, the exit event occurring upon exit of the computer program from the data processing function;
associating the parameter with the exit event; and
based on the function identifier, recording information regarding the entry event and the exit event,
the step of analyzing the recorded information to ascertain a performance characteristic of the specific set of instructions comprising
using the function identifier to attribute a portion of the performance characteristic of the data processing operation to the specific set of instructions.

9. The computer-readable storage medium according to claim 8, wherein
the steps of associating the parameter with the entry event and the exit event comprise creating a unique node of a function call graph, and
the step of analyzing the recorded information comprises identifying balanced enter and exit events associated with the unique node.

10. The computer-readable storage medium according to claim 9, wherein step of providing access comprises providing a user interface, the user interface operable to display the unique node of the function call graph to enable a user to determine how to optimize computer program to optimize for speed or memory usage.

11. A computer-readable storage medium encoded with computer-executable instructions which, when executed by a processor, perform a method for analyzing performance of a computer program at runtime, the computer program comprising a plurality of data processing operations, the method comprising:
identifying a data processing operation comprising a generically-named native code function or a virtual machine dispatch function;
identifying a specific set of instructions executable in connection with the data processing operation;
ascertaining a parameter representing the specific set of instructions; and
invoking a profiling function and passing the parameter to the profiling function, the profiling function configured to
record a predetermined event based on the parameter,
based on the predetermined event, ascertain a performance characteristic of the data processing operation, and
attribute a portion of the performance characteristic to the specific set of instructions via the parameter.

12. The computer-readable storage medium according to claim 11, wherein the method step of invoking a profiling function further comprises:
identifying an instrumented instruction within the computer program, the instrumented instruction comprising a call to the profiling function; and
executing the instrumented instruction.

13. The computer-readable storage medium according to claim 12, wherein the instrumented instruction is selected from the group comprising: a manually inserted instruction; a compiler-inserted instruction; and a simulator-inserted instruction.

14. The computer-readable storage medium according to claim 11, wherein the specific set of instructions is unknown until runtime of the computer program.

15. A system for analyzing performance of a computer program at runtime, the computer program having a plurality of data processing operations, the system comprising:
a computer-readable storage medium; and
a processor responsive to the computer-readable storage medium and to computer-executable instructions, the computer-executable instructions comprising:
an event handling engine invoked by the computer program and executable by the processor to
receive notification of an occurrence of a predetermined event within the computer program, the predetermined event associated with a data processing operation comprising a generically-named native code function or a virtual machine dispatch function,
receive from the computer program a parameter associated with the predetermined event, the parameter representing a specific set of instructions executable in connection with the data processing operation, and
record information regarding the predetermined event, and an analysis engine responsive to the event handling engine and
executable by the processor to analyze the recorded information to ascertain a performance characteristic of the specific set of instructions, a portion of a performance characteristic of the data processing operation attributable to the specific set of instructions based on the parameter.

16. The system according to claim 15, further comprising:
a user interface responsive to the analysis engine to present the performance characteristic of the specific set of instructions to a user.

17. The system according to claim 16, wherein
the analysis engine is further configured to generate a call graph having a node representing the specific set of instructions, and
the user interface is responsive to present the call graph to the user in a manner that enables a user to expand or collapse the node representing the specific set of instructions.

18. The system according to claim 15, wherein the specific set of instructions is unknown until runtime of the computer program.

19. The system according to claim 15, wherein the computer-executable instructions are executable by a client-side processor.

20. The system according to claim 15, wherein the computer-executable instructions are executable by a network-side processor.
